(19) United States
(12) Patent Application Publication
(10) Pub. No.: US 2014/0255261 A1
(43) Pub. Date: Sep. 11, 2014

(54) CELLULAR SUBSTRATE FOR A CATALYTIC CONVERTOR

(71) Applicant: FORD GLOBAL TECHNOLOGIES, LLC, Dearborn, MI (US)

(72) Inventors: Christopher Mark Greiner, Birmingham, MI (US); Lawrence M. Rose, Berkley, MI (US)

(73) Assignee: Ford Global Technologies, LLC, Dearborn, MI (US)

(21) Appl. No.: 13/789,251

(22) Filed: Mar. 7, 2013

(51) Int. Cl. B01J 35/04; B01D 53/94

(52) U.S. Cl. CPC B01J 35/04; B01D 53/94
USPC 422/168; 428/116; 29/890

(57) ABSTRACT

An emissions-control catalyst brick includes a plurality of formed metal ribbons that together define a repeating pattern of open cells. The ribbons are joined together in layers with the open cells of each layer offset from those of the adjacent layer. A catalyst wash coat is applied to the plurality of metal ribbons.

### TECHNICAL FIELD

This application relates to the field of motor-vehicle engineering, and more particularly, to emissions-control catalyst bricks and methods for making the same.

### BACKGROUND AND SUMMARY

An emissions-control device of a motor vehicle typically includes a core, or ‘brick’, made from a ceramic material. The brick may be coated with a catalytic washcoat, which may include a precious-metal catalyst. The catalyst encourages the breakdown of undesirable engine emissions—nitrogen oxides (NOₓ), hydrocarbons, carbon monoxide (CO), and particulates, for example. In the current state-of-the-art, the brick is an assembly of many narrow tubes, or honeycombs, open at one or both ends, with the catalyst coating the inside of each tube.

In some kinetic domains, heterogeneous catalysis of a gas-phase chemical reaction—such as the breakdown of NOₓ or oxidation of CO—is overall faster when the gas flows turbulently over the catalyst. However, the long, thin tubes of a state-of-the-art catalyst brick transport the exhaust gas with relatively little turbulence. Typically, turbulent exhaust flow at the ends of each tube transitions to a laminar flow regime as it travels through the tube. Smooth, laminar flow limits mass transport of the exhaust gasses and reaction products at the catalytic reaction surface.

Furthermore, the individual tubes of the state-of-the-art brick may become clogged over time, due to particulate build-up. This effect not only increases the exhaust back pressure on the engine, but also reduces the catalytically active surface area available to the exhaust, eroding both engine efficiency and emissions-control performance. Finally, the ceramic material from which a state-of-the-art brick is made is invariably brittle and subject to stress-induced fracture. Such fracture may lead to additional clogging.

Accordingly, one embodiment of this disclosure provides an emissions-control catalyst brick comprising a plurality of formed metal ribbons that together define a repeating pattern of open cells. The ribbons are joined together in layers with the open cells of each layer offset from those of the adjacent layer. A catalyst wash coat is then applied to the plurality of metal ribbons. With this structure, exhaust gas flows turbulently throughout the brick, for faster mass transport to and from the catalytic surface of the cells. In addition, overall flow through the brick is less affected by clogging of the individual cells, which do not extend the whole length of the brick. Here, the exhaust flow merely seeks a path around clogged cells. Furthermore, the flexible metallic structure of the brick is much less susceptible to fracture, relative to a ceramic substrate.

The summary above is provided to introduce a selected part of this disclosure in simplified form, not to identify key or essential features. The claimed subject matter, defined by the claims, is limited neither to the content of this summary nor to implementations that address the problems or disadvantages noted herein.

### BRIEF DESCRIPTION OF THE DRAWINGS

FIGS. 1 and 2 show aspects of example engine systems in accordance with embodiments of this disclosure.

FIG. 3 shows aspects of an example emissions-control device in accordance with an embodiment of this disclosure.

FIG. 4 shows a ribbon of a first example catalyst brick in accordance with an embodiment of this disclosure.

FIG. 5 shows a structure of the first example catalyst brick in accordance with an embodiment of this disclosure.

FIG. 6 shows the first example catalyst brick in accordance with an embodiment of this disclosure.

FIG. 7 shows a ribbon of a second example catalyst brick in accordance with an embodiment of this disclosure.

FIG. 8 shows a structure of the second example catalyst brick in accordance with an embodiment of this disclosure.

FIG. 9 shows the second example catalyst brick in accordance with an embodiment of this disclosure.

FIG. 10 shows aspects of another emissions-control device in accordance with an embodiment of this disclosure.

FIG. 11 illustrates an example method for making an emissions-control catalyst brick in accordance with an embodiment of this disclosure.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

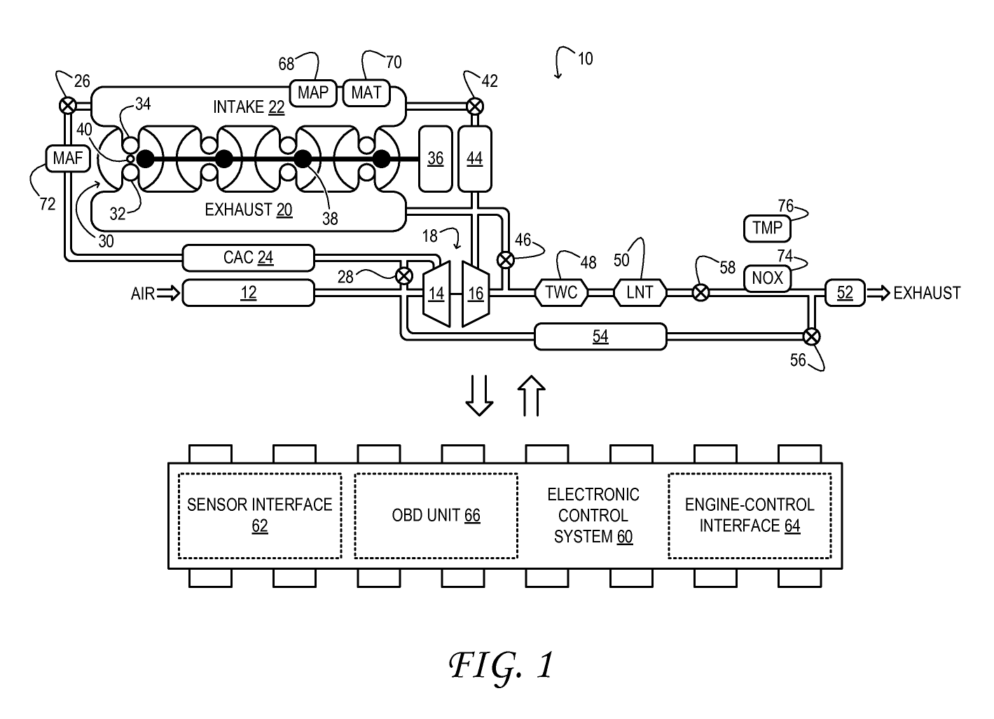

FIG. 1 schematically shows aspects of an example engine system 10 of a motor vehicle. In engine system 10, fresh air is inducted into air cleaner 12 and flows to compressor 14. The compressor may be any suitable intake-air compressor—a motor-driven or driveshaft driven supercharger compressor, for example. In engine system 10, however, the compressor is mechanically coupled to turbine 16 in turbocharger 18, the turbine driven by expanding engine exhaust from exhaust manifold 20. In one embodiment, the compressor and turbine may be coupled within a twin scroll turbocharger. In another embodiment, the turbocharger may be a variable geometry turbocharger (VGT), in which turbine geometry is actively varied as a function of engine speed.

Compressor 14 is coupled fluidically to intake manifold 22 via charge-air cooler (CAC) 24 and throttle valve 26. Pressurized air from the compressor flows through the CAC and the throttle valve en route to the intake manifold. In the illustrated embodiment, compressor by-pass valve 28 is coupled between the inlet and the outlet of the compressor. The compressor by-pass valve may be a normally closed valve configured to open to relieve excess boost pressure under selected operating conditions.

Exhaust manifold 20 and intake manifold 22 are coupled to a series of cylinders 30 through a series of exhaust valves 32 and intake valves 34, respectively. In one embodiment, the exhaust and/or intake valves may be electronically actuated. In another embodiment, the exhaust and/or intake valves may be cam actuated. Whether electronically actuated or cam actuated, the timing of exhaust and intake valve opening and closure may be adjusted as needed for desired combustion and emissions-control performance.

Cylinders 30 may be supplied any of a variety of fuels, depending on the embodiment: gasoline, alcohols, or mixtures thereof. In the illustrated embodiment, fuel from fuel system 36 is supplied to the cylinders via direct injection through fuel injectors 38. In the various embodiments considered herein, the fuel may be supplied via direct injection, port injection, throttle-body injection, or any combination thereof. In engine system 10, combustion is initiated via spark ignition at spark plugs 40. The spark plugs are driven by timed high-voltage pulses from an electronic ignition unit (not shown in the drawings).

Engine system 10 includes high-pressure (HP) exhaust-gas recirculation (EGR) valve 42 and HP EGR cooler 44. When the HP EGR valve is opened, some high-pressure exhaust from exhaust manifold 20 is drawn through the HP EGR cooler to intake manifold 22. In the intake manifold, the high pressure exhaust dilutes the intake-air charge for cooler combustion temperatures, decreased emissions, and other benefits. The remaining exhaust flows to turbine 16 to drive the turbine. When reduced turbine torque is desired, some or all of the exhaust may be directed instead through wastegate 46, by-passing the turbine. The combined flow from the turbine and the wastegate then flows through the various exhaust-aftertreatment devices of the engine system, as further described below.

In engine system 10, three-way catalyst (TWC) device 48 is coupled downstream of turbine 16. The TWC device includes an internal catalyst-support structure to which a catalytic washcoat is applied. The washcoat is configured to oxidize residual CO, hydrogen, and hydrocarbons and to reduce nitrogen oxides (NOₓ) present in the engine exhaust. Lean NOₓ trap (LNT) 50 is coupled downstream of TWC device 48. The LNT is configured to trap NOₓ from the exhaust flow when the exhaust flow is lean, and to reduce the trapped NOₓ when the exhaust flow is rich.

It will be noted that the nature, number, and arrangement of exhaust-aftertreatment devices in the engine system may differ for the different embodiments of this disclosure. For instance, some configurations may include an additional soot filter or a multi-purpose exhaust-aftertreatment device that combines soot filtering with other emissions-control functions, such as NOₓ trapping.

Continuing in FIG. 1, all or part of the treated exhaust may be released into the ambient via silencer 52. Depending on operating conditions, however, some treated exhaust may be diverted through low-pressure (LP) EGR cooler 54. The exhaust may be diverted by opening LP EGR valve 56 coupled in series with the LP EGR cooler. From LP EGR cooler 54, the cooled exhaust gas flows to compressor 14. By partially closing exhaust-backpressure valve 58, the flow potential for LP EGR may be increased during selected operating conditions. Other configurations may include a throttle valve upstream of air cleaner 12 instead of the exhaust back-pressure valve.

Engine system 10 includes electronic control system 60 configured to control various engine-system functions. The electronic control system includes memory and one or more processors configured for appropriate decision making responsive to sensor input and directed to intelligent control of engine-system componentry. Such decision-making may be enacted according to various strategies such as event-driven, interrupt-driven, multi-tasking, multi-threading, and the like. In this manner, the electronic control system may be configured to enact any or all aspects of the methods disclosed hereinafter. Accordingly, the method steps disclosed hereinafter—e.g., operations, functions, and/or acts—may be embodied as code programmed into machine-readable storage media in the electronic control system. In this manner, the ECS may be configured to enact any or all aspects of the methods disclosed herein, wherein the various method steps—e.g., operations, functions, and acts—may be embodied as code programmed into machine-readable storage media in the ECS.

Electronic control system 60 includes sensor interface 62, engine-control interface 64, and on-board diagnostic (OBD) unit 66. To assess operating conditions of engine system 10 and of the vehicle in which the engine system is installed, sensor interface 62 receives input from various sensors arranged in the vehicle—flow sensors, temperature sensors, pedal-position sensors, pressure sensors, etc. Some example sensors are shown in FIG. 1—manifold air-pressure (MAP) sensor 68, manifold air-temperature sensor (MAT) 70, mass air-flow (MAF) sensor 72, NOₓ sensor 74, and exhaust-system temperature sensor 76. Various other sensors may be provided as well.

Electronic control system 60 also includes engine-control interface 64. The engine-control interface is configured to actuate electronically controllable valves, actuators, and other componentry of the vehicle—throttle valve 26, compressor by-pass valve 28, wastegate 46, and EGR valves 42 and 56, for example. The engine-control interface is operatively coupled to each electronically controlled valve and actuator and is configured to command its opening, closure, and/or adjustment as needed to enact the control functions described herein.

Electronic control system 60 also includes on-board diagnostic (OBD) unit 66. The OBD unit is a portion of the electronic control system configured to diagnose degradation of various components of engine system 10. Such components may include oxygen sensors, fuel injectors, and emissions-control components, as examples.

FIG. 2 shows aspects of another engine system 78—a diesel engine in which combustion is initiated via compression ignition. Accordingly, cylinders 30 of engine system 78 are supplied diesel fuel, biodiesel, etc., from fuel system 36. In engine system 78, diesel-oxidation catalyst (DOC) device 80 is coupled downstream of turbine 16. The DOC device includes an internal catalyst-support structure to which a DOC washcoat is applied. The DOC device is configured to oxidize residual CO, hydrogen, and hydrocarbons present in the engine exhaust.

Diesel particulate filter (DPF) 82 is coupled downstream of DOC device 80. The DPF is a regenerable soot filter configured to trap soot entrained in the engine exhaust flow; it comprises a soot-filtering substrate. Applied to the substrate is a washcoat that promotes oxidation of the accumulated soot and recovery of filter capacity under certain conditions. In one embodiment, the accumulated soot may be subject to intermittent oxidizing conditions in which engine function is adjusted to temporarily provide higher-temperature exhaust. In another embodiment, the accumulated soot may be oxidized continuously or quasi-continuously during normal operating conditions.

Reductant injector 84, reductant mixer 86, and SCR device 88 are coupled downstream of DPF 82 in engine system 78. The reductant injector is configured to receive a reductant (e.g., a urea solution) from reductant reservoir 90 and to controllably inject the reductant into the exhaust flow. The reductant injector may include a nozzle that disperses the reductant solution in the form of an aerosol. Arranged downstream of the reductant injector, the reductant mixer is configured to increase the extent and/or homogeneity of the dispersion of the injected reductant in the exhaust flow. The reductant mixer may include one or more vanes configured to swirl the exhaust flow and entrained reductant to improve the dispersion. Upon being dispersed in the hot engine exhaust, at least some of the injected reductant may decompose. In embodiments where the reductant is a urea solution, the reductant will decompose into water, ammonia, and carbon dioxide. The remaining urea decomposes on impact with the SCR catalyst (vide infra).

SCR device 88 is coupled downstream of reductant mixer 86. The SCR device may be configured to facilitate one or more chemical reactions between ammonia formed by the decomposition of the injected reductant and NOₓ from the engine exhaust, thereby reducing the amount of NOₓ released into the ambient. The SCR device comprises an internal catalyst-support structure to which an SCR washcoat is applied. The SCR washcoat is configured to sorb the NOₓ and the ammonia, and to catalyze the redox reaction of the same to form dinitrogen (N₂) and water.

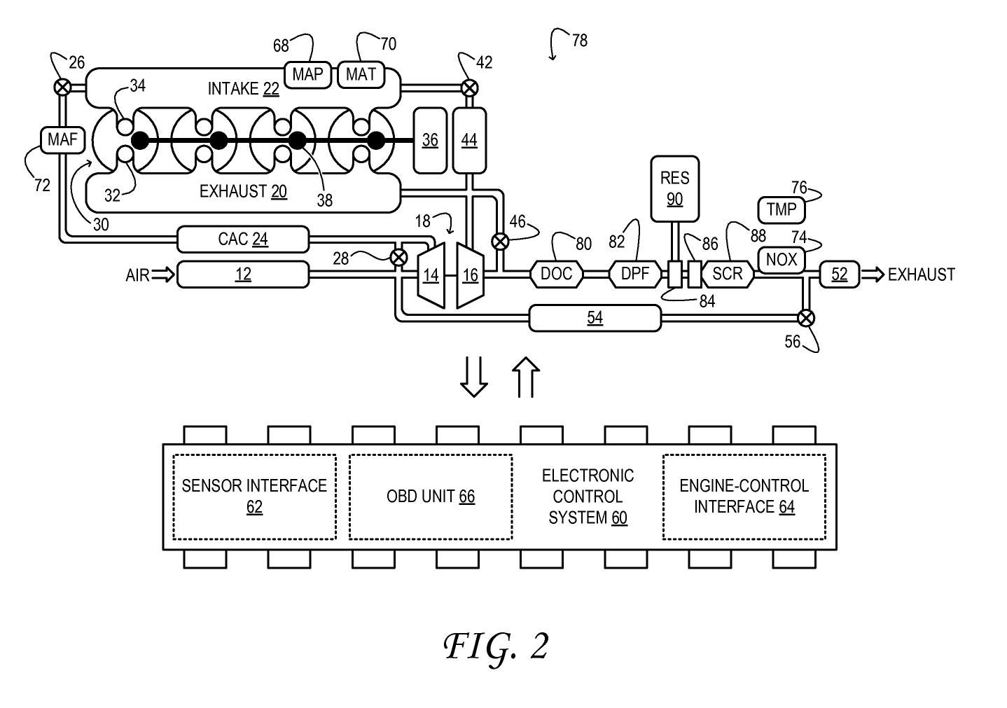

The engine systems described above include various emissions-control devices—TWC device 48, LNT 50, DOC device 80, DPF 82 and SCR device 88, for example. Any, some, or all of these devices may include an emissions-control catalyst brick 92 inside an enclosure 94, as shown for generic emissions-control device 96 of FIG. 3. The emissions-control catalyst brick may include a plurality of formed metal ribbons that together define a repeating pattern of open cells. The ribbons may be joined together in layers with the open cells of each layer offset from those of the adjacent layer, as further described below. In the embodiments here contemplated, a catalyst wash coat appropriate for any of the above emissions-control devices may be applied to the plurality of metal ribbons to support the desired catalytic activity.

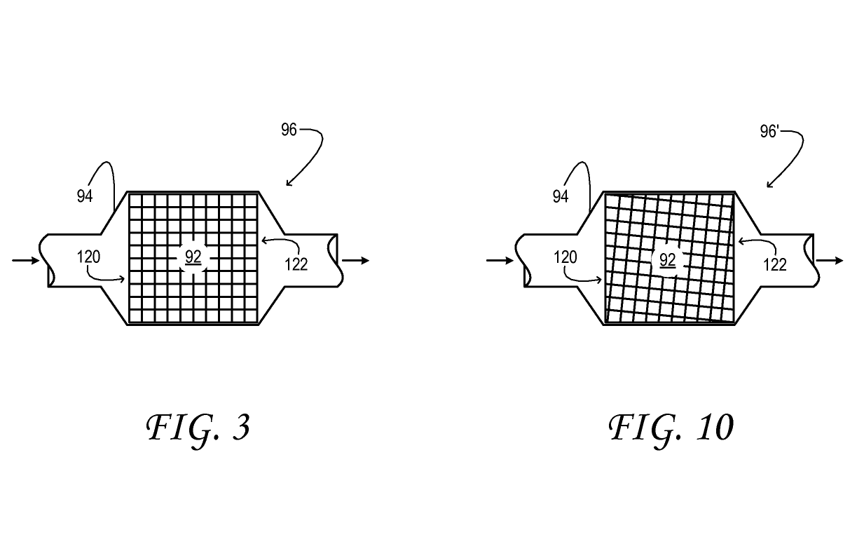

FIGS. 4, 5, and 6 show aspects of an example catalyst brick 92A in one embodiment. FIG. 4 shows a single formed metal ribbon 98A that may serve as a building block for the catalyst brick. In one embodiment, the ribbon may be comprise a stainless-steel alloy. In other embodiments, the ribbon may comprise titanium or any other suitably strong and flexible refractory metal. In the embodiment of FIG. 4, the ribbon is folded along fold lines 100 into a series of repeating triangular wall portions 102A. The ribbon may be one to ten millimeters in width W, and as long as needed to span the brick.

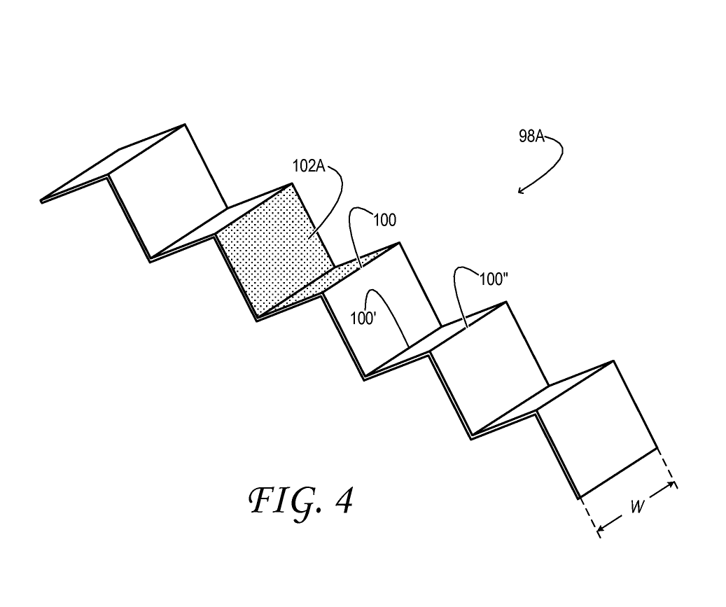

FIG. 5 shows a partial structure of catalyst brick 92A. In this structure, a plurality of ribbons 98A are joined together in layers 104. For purposes of illustration, only two layers are shown in the drawing; in practice, the brick could include dozens or hundreds of layers. Each layer may be one to ten millimeters in thickness, a distance corresponding to the width of one ribbon. Arranged in this manner, the ribbons together define a repeating pattern of open cells 106. In one embodiment, each open cell is one to one-hundred square millimeters in cross-sectional area. As shown in the drawing, each layer presents a plurality of open cells; each open cell includes an open inlet end 108 opposite an open outlet end 110, with a plurality of wall portions 102 disposed adjacent the inlet and outlet ends. In this and other embodiments, each open cell is a rectangular prism having four closed wall portions adjacent the inlet and outlet ends.

Catalyst brick 92A is configured to conduct exhaust from inlet end 108 to outlet end 110 of each open cell 106. In the embodiment as illustrated, the wall portions are parallel to each other and to the direction of exhaust flow through the brick. In other embodiments, the wall portions may be oblique to the direction of exhaust flow through the brick, to enhance flow separation and turbulence.

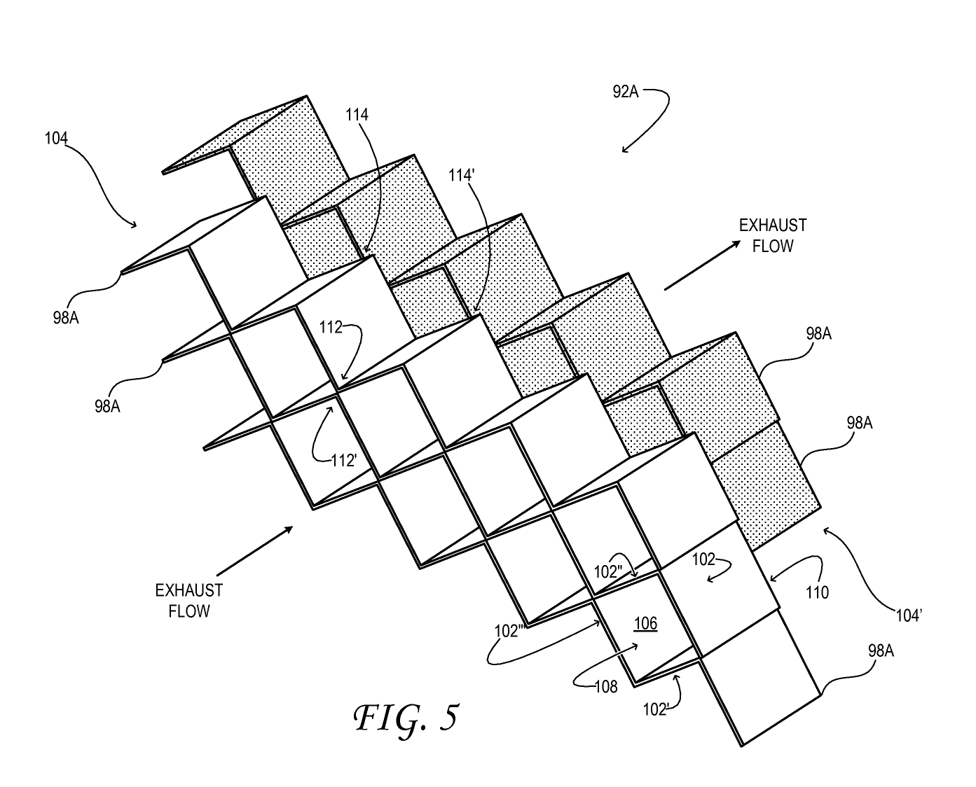

In the embodiment of FIG. 5, adjacent ribbons 98A of a given layer 104 are arranged with fold lines 100 parallel. The ribbons are joined at apices 112 of the triangular wall portions to form the open cells 106. Furthermore, adjacent layers of open cells are joined together at points of intersection 114 between the formed ribbons of one layer and the formed ribbons of an adjacent layer. In this and other embodiments, the open cells of each layer are offset from those of the adjacent layer. In some embodiments, adjacent layers of the brick are offset by about one-half of a width and/or height of one of the open cells, as shown in the drawings. FIG. 6 shows a fully formed catalyst brick 92A in one embodiment.

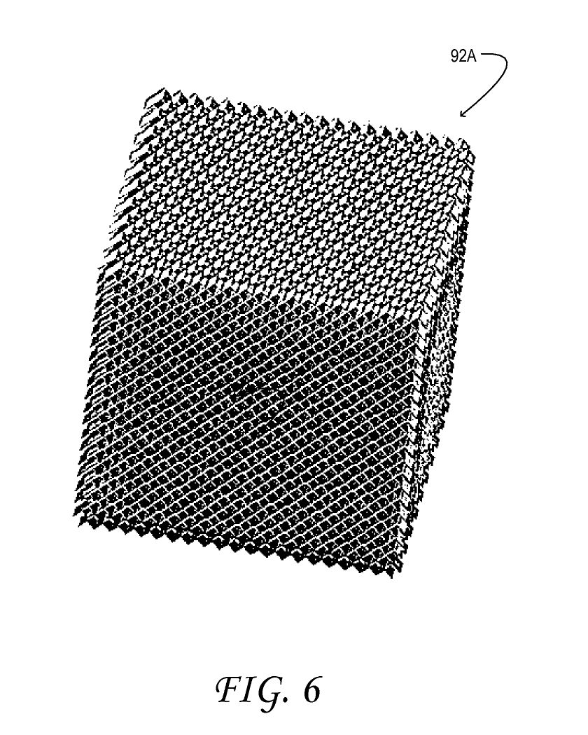

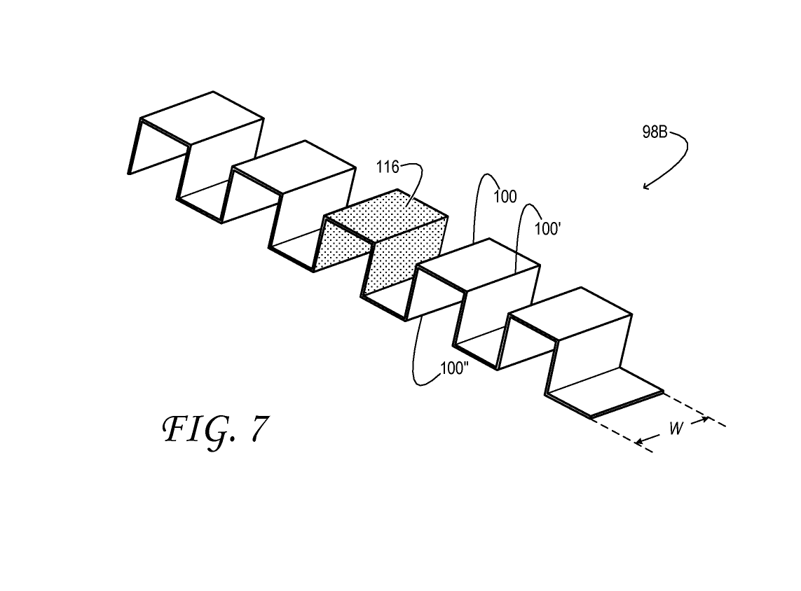

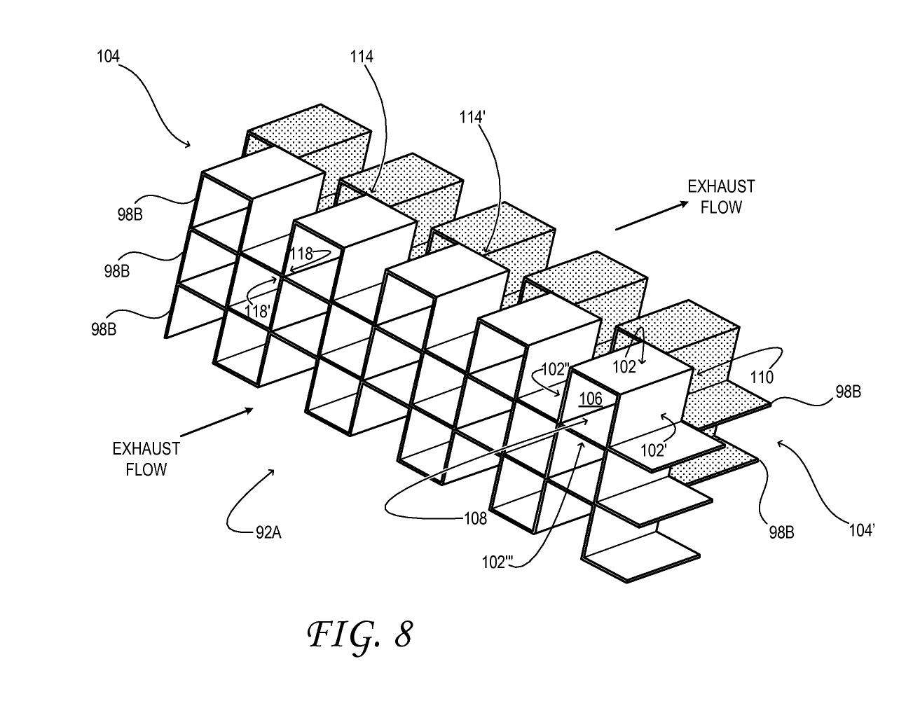

FIGS. 7, 8, and 9 show aspects of another example catalyst brick 92B. This embodiment is like the previous, except that each ribbon 98B is folded into a series of repeating rectangular wall portions 116, as shown in FIG. 7. Referring now to FIG. 8, adjacent ribbons of a given layer 104 are arranged with fold lines 100 parallel, as in the previous embodiment. The ribbons are joined at the corners 118 of the rectangular wall portions to form open cells 106.

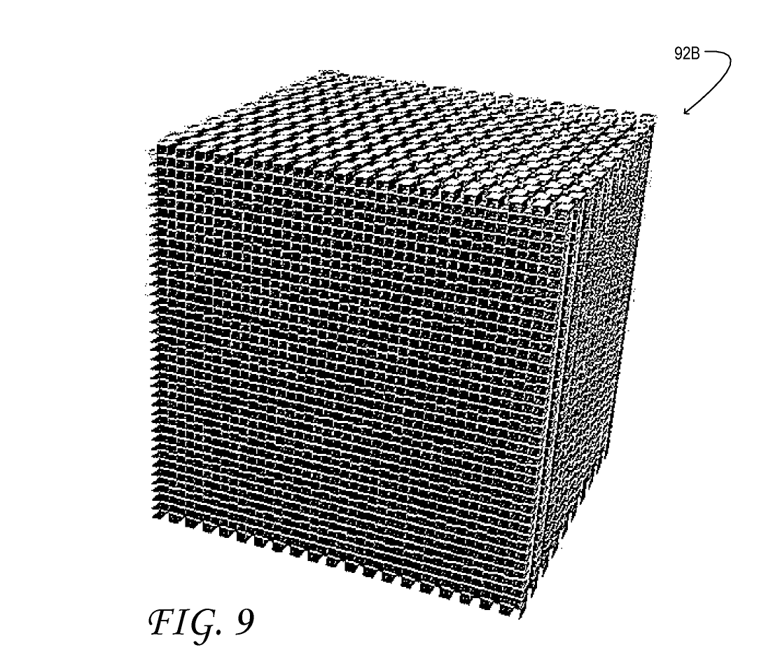

Returning now to FIG. 3, enclosure 94, which surrounds brick 92, is configured to receive engine exhaust, to guide the exhaust into the plurality of open cells of an inlet layer 120 of the brick, and to collect the exhaust released from the plurality of open cells of an outlet layer 122 of the brick. In this embodiment, the enclosure supports the brick with its layers of formed metal ribbons perpendicular to the net flow direction of exhaust through the device. In emissions-control device 96′ of FIG. 10, by contrast, enclosure 94 supports brick 92 with its layers of formed metal ribbons oblique to the net flow direction of exhaust through the device. This configuration further increases the degree of turbulence in the exhaust flow through the brick, which may increase mass-transport limited rates of the catalytic reactions therein.

No aspect of the above drawings or description should be understood in a limiting sense, for numerous other embodiments are within the spirit and scope of this disclosure. For instance, instead of the various layers of the catalyst brick being flat and parallel to each other, as shown in the drawings, the layers may be concentric like those of a jelly roll. This structure may be used in a cylindrical brick, which is supported in a cylindrical enclosure, for example.

The configurations described herein enable various methods for making an emissions-control catalyst brick. Accordingly, some such methods are now described, by way of example, with continued reference to the above configurations. It will be understood, however, that the methods here described, and others within the scope of this disclosure, may be enabled by different configurations as well. Further, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

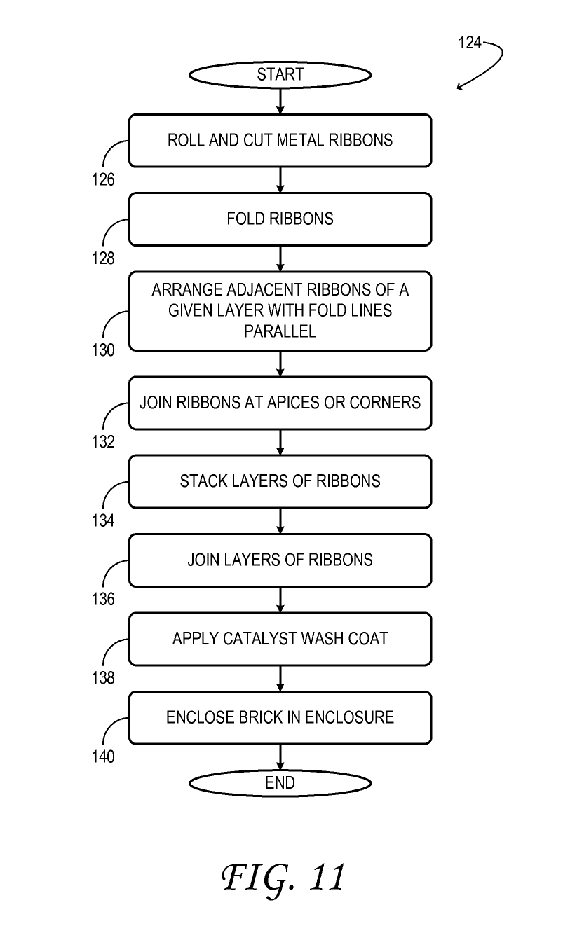

FIG. 11 illustrates an example method 124 for making an emissions-control catalyst brick in one embodiment. At 126 of method 124, a plurality of metal ribbons are formed by rolling and cutting the ribbons from sheet metal (e.g., stainless steel or titanium) stock. Such operations may be executed with a tool similar to one used in making radiator fins. At 128 the ribbons are folded into a series of repeating triangular or rectangular wall portions. At 130 adjacent ribbons of a given layer are arranged with fold lines parallel. At 132 adjacent ribbons of the given layer are joined at the apices or corners of the wall portions to form the open cells of the catalyst brick. At 134 the layers of folded metal ribbons are stacked with open cells of adjacent layers offset from one another. In this manner are formed a plurality of metal ribbons that together define a repeating pattern of open cells. At 136 the offset layers are joined at points of intersection between the formed ribbons of one layer and the formed ribbons of an adjacent layer. Adjacent layers may be joined by induction welding, in one embodiment. Thus, the ribbons may be joined together in layers, with the open cells of each layer offset from those of the adjacent layer. At 138 of method 124, a catalyst wash coat is applied to the joined ribbons. At 140 the stacked layers of folded metal ribbons are enclosed in a polyhedral enclosure. The enclosure may be rectangular prismatic or hexagonal prismatic in some embodiments—shaped as needed to sealably accommodate the enclosed catalyst brick.

In certain other methods, the layers of folded metal ribbons may be rolled into a jellyroll configuration (c.f., 134 of method 124) instead of being stacked. In that embodiment, the rolled layers of folded metal ribbons may be enclosed in a cylindrical enclosure. In another stacked configuration, a long sheet of a structure and thickness corresponding to one layer 104 of the catalyst brick may be formed via a continuous process. That sheet may be folded in a zig-zag pattern to form parallel layers, which are subsequently joined together to form a rectangular prismatic brick.

It will be understood that the articles, systems, and methods described hereinabove are embodiments of this disclosure—non-limiting examples for which numerous variations and extensions are contemplated as well. This disclosure also includes all novel and non-obvious combinations and sub-combinations of the above articles, systems, and methods, and any and all equivalents thereof.

1. An emissions-control catalyst brick comprising:
a plurality of formed metal ribbons that together define a repeating pattern of open cells, the ribbons joined together in layers with the open cells of each layer offset from those of the adjacent layer; and
a catalyst wash coat applied to the plurality of metal ribbons.

2. The brick of claim 1 wherein the ribbons are of a stainless-steel alloy.

3. The brick of claim 1 wherein each layer is one to ten millimeters in thickness, and wherein each open cell is one to one-hundred square millimeters in cross-sectional area.

4. The brick of claim 1 wherein each open cell includes an open inlet end opposite an open outlet end and a plurality of wall portions adjacent the inlet and outlet ends, and wherein the wall portions are parallel to each other and to the direction of exhaust flow through the brick.

5. The brick of claim 1 wherein each open cell includes an open inlet end opposite an open outlet end and a plurality of wall portions adjacent the inlet and outlet ends, and wherein the wall portions are oblique to the direction of exhaust flow through the brick.

6. The brick of claim 1 wherein each open cell is a rectangular prism having an open inlet end opposite an open outlet end and four closed wall portions adjacent the inlet and outlet ends, and wherein the brick is configured to conduct exhaust from the inlet end to the outlet end of each open cell.

7. The brick of claim 1 wherein the adjacent layers of open cells are joined together at points of intersection between the formed ribbons of one layer and the formed ribbons of an adjacent layer.

8. The brick of claim 1 wherein each ribbon is folded into a series of repeating triangular wall portions, wherein adjacent ribbons of a given layer are arranged with fold lines parallel and joined at the apices of the triangular wall portions to form the open cells.

9. The brick of claim 1 wherein each ribbon is folded into a series of repeating rectangular wall portions, wherein adjacent ribbons of a given layer are arranged with fold lines parallel and joined at the corners of the rectangular wall portions to form the open cells.

10. The brick of claim 1 wherein the adjacent layers are offset by about one-half of a width and/or height of one of the open cells.

11. The brick of claim 1 wherein the washcoat is one or more of a three-way catalyst (TWC) washcoat, a diesel-oxidation catalyst (DOC) washcoat, a lean NOₓ trap (LNT) washcoat, and a selective catalytic reduction (SCR) washcoat.

12. A method for making an emissions-control catalyst brick, comprising:
forming a plurality of metal ribbons that together define a repeating pattern of open cells;
joining the ribbons together in layers with the open cells of each layer offset from those of the adjacent layer; and
applying a catalyst wash coat to the ribbons.

13. The method of claim 12 further comprising joining the offset layers at points of intersection between the formed ribbons of one layer and the formed ribbons of an adjacent layer.

14. The method of claim 13 wherein joining together includes joining by induction welding.

15. The method of claim 12 wherein forming the plurality of metal ribbons includes rolling and cutting the ribbons.

16. The method of claim 12 wherein forming the plurality of metal ribbons includes:
folding the ribbons into a series of repeating triangular or rectangular wall portions;
arranging adjacent ribbons of a given layer with fold lines parallel; and
joining the adjacent ribbons of the given layer at the apices or corners of the wall portions to form the open cells.

17. The method of claim 16 further comprising stacking the layers of folded metal ribbons and enclosing the stacked layers of folded metal ribbons in a polyhedral enclosure.

18. The method of claim 16 further comprising rolling the folded metal ribbons and enclosing the rolled layers of folded metal ribbons in a cylindrical enclosure.

19. An emissions-control device comprising:
a brick having a plurality of formed metal ribbons that together define a repeating pattern of open cells, the ribbons joined together in layers with the open cells of each layer offset from those of the adjacent layer;
a catalyst wash coat applied to the plurality of metal ribbons; and
surrounding the brick, an enclosure configured to receive engine exhaust, to guide the exhaust into the plurality of open cells of an inlet layer of the brick, and to collect the exhaust released from the plurality of open cells of an outlet layer of the brick.

20. The emissions-control device of claim 19 wherein the enclosure supports the brick with its layers of formed metal ribbons oblique to the net flow direction of exhaust through the device.
